(19) United States
(12) Patent Application Publication
(10) Pub. No.: US 2021/0317934 A1
(43) Pub. Date: Oct. 14, 2021

(54) RETAINING RING SYSTEM AND METHOD OF USE

(71) Applicant: Todd Anthony Travis, Humble, TX (US)

(72) Inventor: Todd Anthony Travis, Humble, TX (US)

(21) Appl. No.: 16/844,315

(22) Filed: Apr. 9, 2020

(51) Int. Cl. F16L 21/06; F16L 3/10

(52) U.S. Cl. CPC F16L 21/06; F16C 33/58; F16L 3/1066

(57) ABSTRACT

A retaining ring system and method of use for fastening two components together. The retaining ring in one embodiment can have a hexagon cross-sectional shape, and in use can be housed between two grooves on adjacent conduits that can have an isosceles trapezoidal shape. The grooves can be configured so that if a bearing surface of one component having a perpendicular line emanating away from it would cross somewhere along an opposite bearing surface of the second component.

### BACKGROUND

### Technical Field

The present disclosure relates to a retaining ring. More particularly, and not by way of limitation, the present disclosure is directed to a system and method for a retaining ring that, in one embodiment, can be in the cross sectional shape of a hexagon and housed in two separate isosceles trapezoidal grooves on two coupled pieces.

### Background

This background section is intended to provide a discussion of related aspects of the art that can be helpful to understanding the embodiments discussed in this disclosure. It is not intended that anything contained herein be an admission of what is or is not prior art, and accordingly, this section should be considered in that light.

When coupling two pipes or other pieces that are slidably connected together, often a retainer ring will be used to hold the two components together. If fluid is moving through two pipes, the pressure exerted on the pipes tends to cause the pipes to pull apart. A retainer ring can be placed in grooves formed adjacent to each other in each of the pipes to hold the two pipes together. Upon application of pressure and as the two pipes try to pull apart, the shoulders or bearing surfaces of the retaining ring butt up against the walls of the grooves and prevent the pipes from separating. As a result, the connection of the pipes is held in place without requiring other means of holding the pipes together such as collars or thread connectors.

As pressure is applied to the pipe and force applied to the bearing surfaces of the retainer ring and grooves, the typical rectangular or square retainer ring is subject to a shear force. A shear force occurs when the load on an object is due to the force that results from part of the object attempting to move away from a parallel part of the object. A classic example of a shear force in action is scissors cutting through paper.

In the energy sector, especially when moving large amounts of fluid under high pressure, a shear ring can be used to hold two pipes together while the connection is under high pressure. The shear ring sits in adjacent grooves on the coupled pipes and endures the load. The grooves can have a rectangular shape that allow for the shear ring that has a rectangular cross-section to fit between the grooves. As the grooves in the two pipes attempt to move past each other, the shear ring holds the two pipes together.

One of the issues that develops from using rectangular or square shear rings is the size necessary to handle the high pressures that are present in oil and gas operations such as hydraulic fracturing. For example, a shear ring rated for 4000 psi must be approximately 8 inches wide to handle the loads. Alternatively, ball bearings could be used, but this requires five rows of ball bearings, adding approximately 11 inches in length to the pipe connection.

The configuration of pipes is significantly affected by the length of the connection used to hold the pipes together. The longer the connection, the longer the straight connector portion of a coupled pipe needs to be. For an elbow, this means that the joint cannot begin an immediate bend when used for extremely high pressures. What is needed is a type of connector with a shorter length that can handle the high pressures of hydraulic fracturing.

It would be advantageous to have a retaining ring system and method of use that overcomes the disadvantages of the prior art. The present disclosure provides such a system and method.

### BRIEF SUMMARY

This summary provides a discussion of aspects of certain embodiments of the invention. It is not intended to limit the claimed invention or any of the terms in the claims. The summary provides some aspects but there are aspects and embodiments of the invention that are not discussed here.

The present disclosure is of a retaining ring shaped such that the retaining ring is subject to compression forces under load. The retaining ring can be constructed of multiple segments placed end-to-end to form a ring around a center aperture. Each segment can have a cross-sectional shape of a hexagon. The segmented hexagon ring can be housed between two adjacent grooves in the two components to be connected. These grooves can be in the shape of a portion of an isosceles trapezoid to mate with the hexagon ring. The two components can be conduits that are coupled together to allow fluid to travel between the two conduits. The angled surfaces of the hexagon can function as bearing surfaces that butt up against the angled sides of the grooves and hold the two conduits in place when the conduits are under pressure.

By configuring a bearing surface of the groove of the first component that puts pressure on an adjacent bearing surface of the matching segmented ring such that a perpendicular line from the bearing surface of the segmented ring at the first component intersects bearing surfaces of the second component on the opposite side of the segmented ring, the segmented ring is placed in compression rather than shear when a load is applied to the two components. This increases the amount of force the segmented ring can withstand compared to a square or rectangular ring of the same length.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a cross-section view of a segmented ring housed between two different grooves in two connected components.

FIG. 2 is a perspective assembly view of a segmented ring with a cross-sectional hexagon shape.

FIG. 3 is an exploded view of an embodiment of a segmented ring with a cross-sectional hexagon shape.

FIG. 4 is an assembly section perspective view of an embodiment of a segmented ring with a cross-section hexagon shape utilized in a diverter assembly.

FIG. 5 is a cross-section view of a fluid conduit system utilizing an embodiment of a segmented ring housed between two conduit elements and a loading port for installing the segments.

FIG. 6 is an assembly section perspective view of a union connector utilizing an embodiment of a segmented ring housed between a collar and a pipe.

FIG. 7 is a cross-section view of an adjustable expansion spool utilizing an embodiment of a segmented ring.

FIG. 8 is a cross-section view of a curved joint utilizing an embodiment of a segmented ring in a threaded union configuration on the bottom and a segmented swivel ring configuration on the top.

FIG. 9 is an assembly cross-section view of an isolation diverter utilizing an embodiment of a segmented ring in a swivel configuration with a cross-sectional hexagon shape.

FIG. 10 is an assembly top view of an embodiment of a segmented ring.

FIG. 11 is an assembly perspective view of the segmented ring of FIG. 10.

### DETAILED DESCRIPTION

All illustrations of the drawings are for the purpose of describing selected versions of the present invention and are not intended to limit the scope of the present invention. The present invention can be constructed of a wide variety of materials that are known to one of ordinary skill in the art. However, it preferred that the present invention be constructed of a material that is strong, durable, tough, weather-resistant and/or easily manufacturable.

When an object is experiencing a stress that pushes on the object tending to cause the object to shrink in size, then the object is under a compression stress. The disclosure herein provides a retainer ring design that is under a compression stress, as opposed to a shear stress, under load. Although the disclosure herein is directed to embodiments related to the connection of fluid connections, the retainer ring design disclosed herein can be used in any application where retainer rings are utilized. For example, fluid line connections, hydraulic systems, rotating parts secured together, thrust bearings, transmission gears, etc. are all applications in which the retainer ring disclosed could be implemented. Additionally, although the disclosure is discussed in terms of rings, the same design could be utilized in straight or flat retainer systems (rather than circular rings) that are used to keep two components from moving with respect to each other such as keyways on a shaft.

In the context of connecting two conduit pipes together, a segmented ring can be housed between the two pipes in grooves. The grooves are adjacent to each other and open to each other. Both grooves can have an isosceles trapezoidal shape. The segmented ring has a cross-sectional hexagon shape that matches the shape of the two grooves when aligned with each other. This allows for the segmented ring to mate with the grooves.

When one of the pipes attempts to move parallel to the other pipe, the corresponding grooves will also move relative to each other. As a result, each groove has a bearing surface that pushes on an adjacent bearing surface on the segmented ring housed between the grooves. The grooves are configured such that a perpendicular line from the center of the bearing surface of the first pipe crosses somewhere along the bearing surface of the second pipe. When pressure is applied to the pipes, the bearing surfaces of the groove push on the segmented ring, attempting to decrease its dimensions. The perpendicular line from the bearing surface corresponds with the load path traveling through the segmented ring. The amount of pressure that the segmented ring before failure is significantly increased by placing the ring under compression rather than shear.

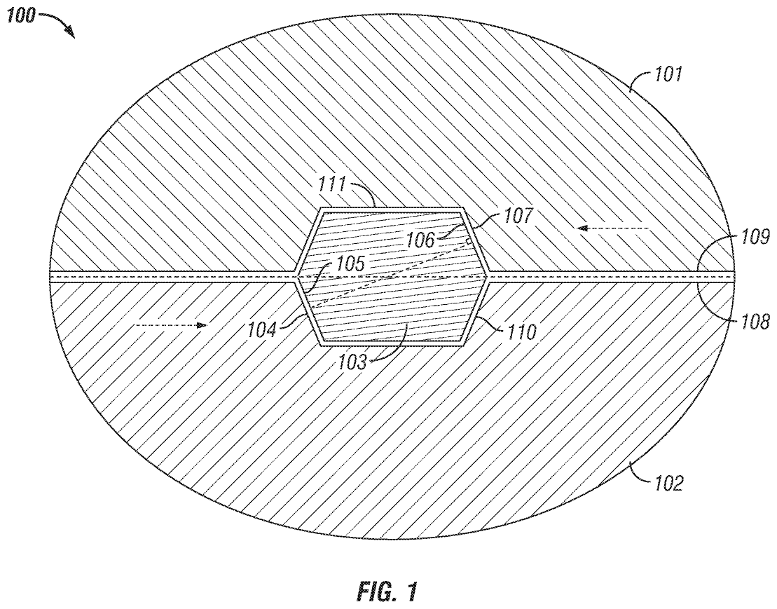

FIG. 1 is a cross-section view of a retaining ring housed between two different grooves in separate components. The first component 101 is adjacent a second component 102 such that a first interface surface 109 is adjacent to a second interface surface 108, and the ring 103 is housed between the first groove 111 in the first component 101 and the second groove 110 in the second component 102. The first groove 111 and the second groove 110 can each have an isosceles trapezoidal cross-sectional shape that mates with the hexagonal cross-section of the ring 103.

After the components are assembled as shown in FIG. 1 and the ring 103 inserted, the first component 101 can be pulled by operating forces such that the first bearing surface 107 of the first component 101 pushes on the first ring bearing surface 106. As a result, the second ring bearing surface 105 is pushed against the second bearing surface 104 of the second component 102, creating a compression force in the ring 103.

As shown in FIG. 1, the bearing surfaces 104, 105, 106, 107 are configured such that a perpendicular line drawn from the center of the first bearing surface 107 of the first groove 111 intersects the second bearing surface 104 of the second groove 110 in the second component 102. By designing the segmented ring 103 and the grooves in this manner, when pressure is applied, compression force is applied to the segmented ring 103 rather than a shear force. The segmented ring can be made of a wide variety of materials including a stainless metal alloy.

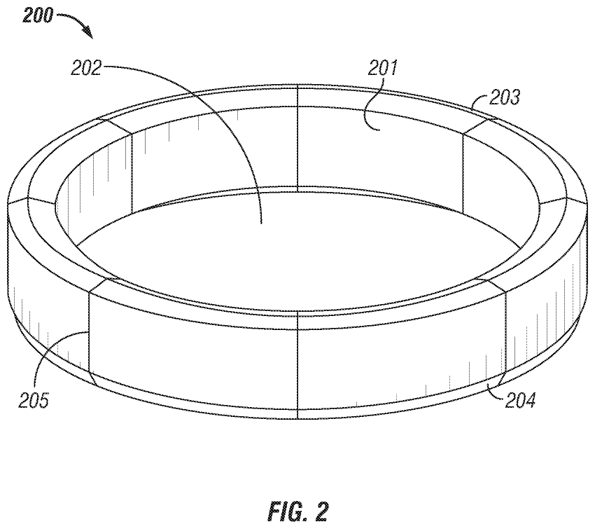

FIG. 2 is a perspective assembly view of a segmented ring with a cross-sectional hexagon shape. Each segment 201 of the segmented ring 200, when placed end-to-end forms an assembled ring around a center aperture 202. Individual segments of the segmented ring 200 each have a hexagonal cross-section, and each segment's cross-section surface can be mated with adjacent segments along a segment interface 205. The segmented ring 200 can be housed between a first groove (not shown) in a first component and a second groove (not shown) in a second component. Both grooves can have an isosceles trapezoidal shape. This shape allows for the ring 200 to be placed in compression rather than shear as discussed above with reference to FIG. 1.

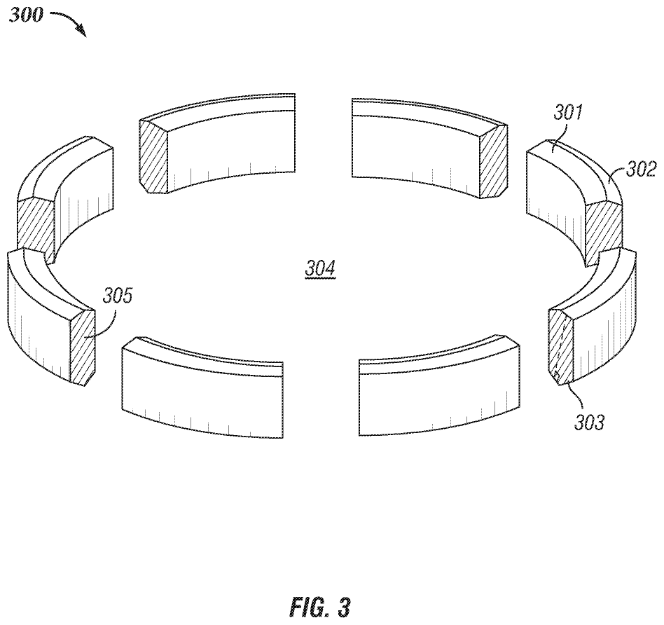

FIG. 3 is an exploded view of an embodiment of a segmented ring with a cross-sectional hexagon shape. The hexagon cross section of each segment 301 allows for a first ring bearing surface 302 and a second ring bearing surface 303 to be put under a compression force when housed in the adjacent grooves of two components having a matching shape (not shown) and an operating load applied. Although the disclosure herein is directed to a segmented ring to allow for insertion of the ring during assembly, the ring need not be segmented depending on the application. A single piece ring could be used. Other methods of installation of such a ring could be devised without departing from the scope and spirit of the disclosure.

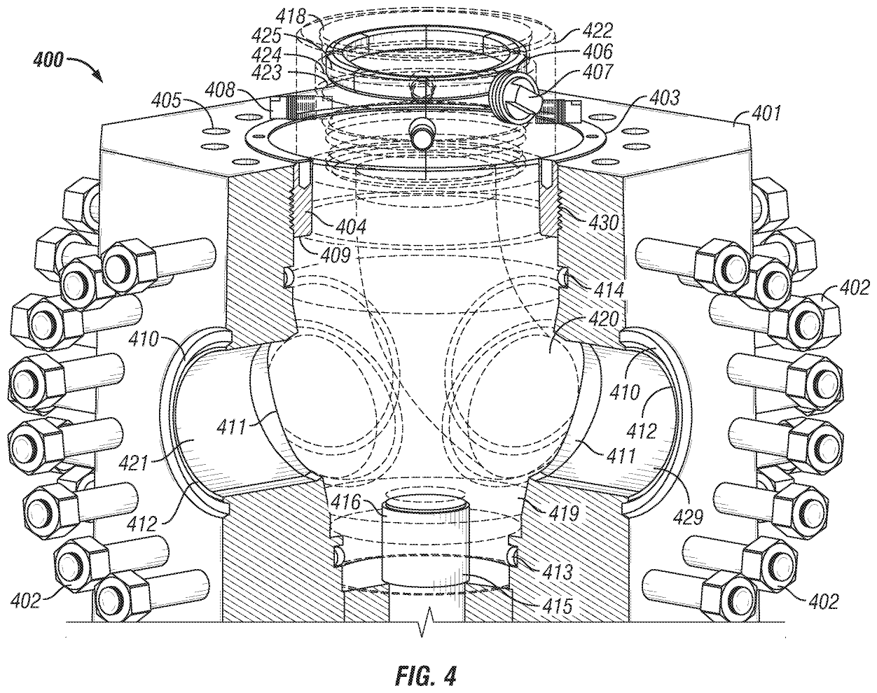

FIG. 4 is an assembly section perspective view of an embodiment of a segmented ring with a cross-section hexagon shape utilized in a diverter assembly. The diverter body 401 has multiple outlet ports 421, 429 and each have an outlet aperture 412. The plug 419 is positioned inside the diverter body 401 such that it is capable of being sealed against the diverter body 401. When sealed in an appropriate orientation, fluid leaving an inlet fluid chamber 418 of the inlet port 422 is directed through the plug fluid chamber 420 into the desired outlet port 429.

By unlocking the lock ring and bonnet ring and applying pressure through a fluid port to lift the plug 419, the plug 419 can be reoriented so that it is connected to a different connection port 411 on a different outlet port 429. Upon reorienting the plug 419, fluid is directed to a different wellhead that is connected to the newly connected outlet port 429.

The inlet pipe 422 can be connected to the plug 419 utilizing a segmented retaining ring. To install the segmented ring in the diverter assembly 400, a retainer hole 406 is provided that can be accessed by removing retainer plug 407. Segments of the retaining ring, such as those shown in FIG. 3, can then be inserted one by one into the passageway formed by inlet groove 424 in the inlet pipe 422 and plug groove 425 in the plug 419. Once all of the segments have be inserted to form an assembled ring around the passageway, the retainer plug 407 can be replaced in the retainer hole 406 to seal it off. Threaded mounting studs 408 can also be used to further secure the inlet pipe 422 to the plug 419.

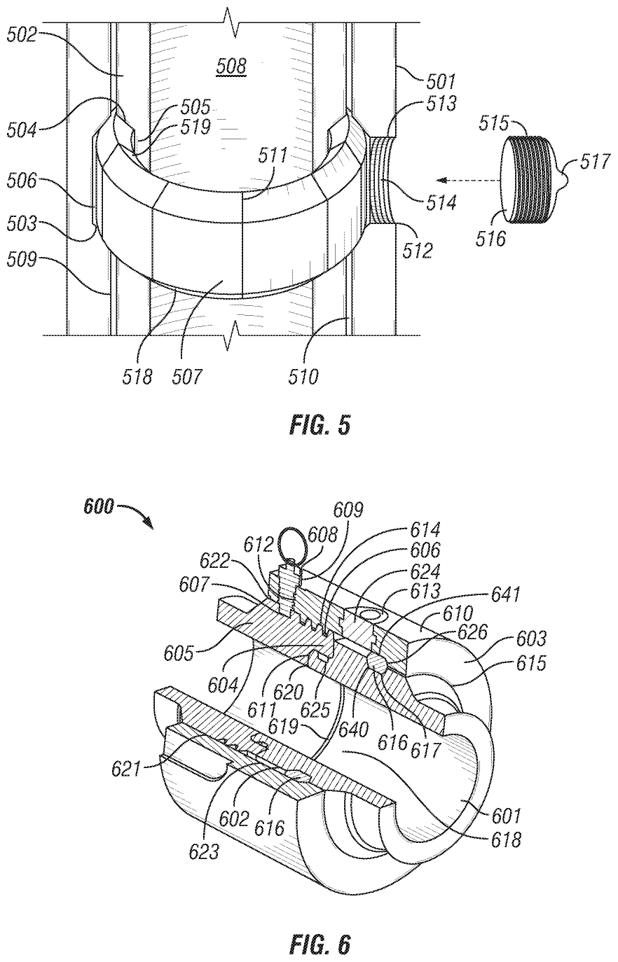

FIG. 5 is a cross-section view of a fluid conduit system utilizing a segmented ring housed between the two conduit elements and a loading port for installing the segments. The first conduit 501 can be pushed over second conduit 502 so that the first inner surface 509 of the first conduit is adjacent to and parallel with the second outer surface 510 of the second conduit 502. The segmented ring 507 can be housed between the first groove 506 of the first conduit 501 and the second groove 505 of the second conduit 502.

After the second conduit 502 has been inserted into the first conduit 501 and the grooves 505, 506 aligned, the segmented ring 507 may be inserted through the retainer aperture 513 into the space between the grooves of the first conduit 501 and the second conduit 502. As the segments are inserted one by one, they line up end-to-end to form the assembled ring once all of the segments have been inserted. When all of the segments of the ring have been inserted and the segmented ring 507 has been properly assembled and positioned, the retainer hole 513 may be closed using retainer plug 517.

FIG. 6 is an assembly section perspective view of a union connector utilizing an embodiment of the segmented ring housed between a collar and a pipe. A male pipe end 618 of a male pipe 601 can be inserted through a first aperture 615 of a collar 603. The outside diameter of a male pipe exterior surface 602 is slightly smaller than the inside diameter of the collar interior surface 623. This allows for the inserted male pipe 601 to continue passing through the collar 603 until the male pipe end 618 meets a female pipe 605. The female pipe 605 can be inserted into the collar 603 through a second aperture 622. Along the female pipe exterior surface 621 of the female pipe 605 there is a first threaded surface 606. The first threaded surface 606 matches with a second threaded surface 614 located along the collar inner surface 623 of the collar 603.

As the female pipe end 604 is inserted into the collar 603, the first threaded surface 606 threads with the matching second threaded surface 614 of the collar and, as a result, the female pipe 605 is coupled to the collar 603. Once inserted into the collar 603, the female pipe 605 is located adjacent to the male pipe 601. The male pipe 601 and female pipe 605 interface along a male/female interface 611. A retainer hole 613 located on the collar exterior surface 610 of the collar 603 which allows passage through the collar. Near the male/female interface 611, a seal groove 625 which traverses the entire circumference of the male pipe exterior surface 602. An o-ring (not shown) can be housed in the seal groove 625 to create a seal in the union connection assembly 600.

The isosceles trapezoidal shape of the male pipe groove 617 and the hexagonal shape of each the ring segment allow the ring segment 616 to be placed in compression instead of shear during operation as discussed above. The segmented ring 616 can be installed in a similar manner to that discussed above with respect to other applications. However, for this particular application, the retainer hole is not located directly over the ring 616 when the union connector is fully assembled as shown in FIG. 5. Thus, the retainer ring can be installed as the pieces are being put together. Specifically, as the collar 603 is being screwed onto the threads of the female pipe 606, the retainer hole will align with the male pipe groove 617 and the segmented ring can be inserted. Once inserted, the collar 603 can be further tightened to the fully assembled position.

The collar groove 626 also has a partial isosceles trapezoidal shape that abuts against the segmented ring 616 as the assembly is tightened. The result is that the segmented ring 616 is securely housed between the male pipe exterior surface 602 and the collar inner surface 623. Other embodiments of the collar groove 626 could have a full isosceles trapezoidal shape, not a partial isosceles trapezoidal shape as shown in FIG. 1. After the segmented ring 616 has been inserted through the retainer hole 613, a retainer plug 624 can be inserted and secured into the retainer hole 613.

Near the second aperture 622 on the collar 603 is a locking pin hole 609. The locking pin hole 609 allows access through the collar 603 for a locking pin 608. When the female pipe 605 has been inserted and threaded into the collar 603, the locking pin hole 609 is aligned with a pocket 607 located on the female pipe exterior surface 621. The locking pin 608 can be inserted through the locking pin hole 609 and into the pocket 607 to lock the collar 603 in place. A locking pin threaded surface 612 matches with corresponding threaded surface on the locking pin 608. When the male pipe 601 and the female pipe 605 have been inserted and secured inside the collar 603, the segmented ring 616 has been housed between the male pipe groove 617 and collar groove 626, and the locking pin 608 has been inserted through the collar 603 into the pocket 607 on the female pipe 605, the union connection has been successfully assembled and sealed without utilizing a hammer or a torque assistance device to create the seal.

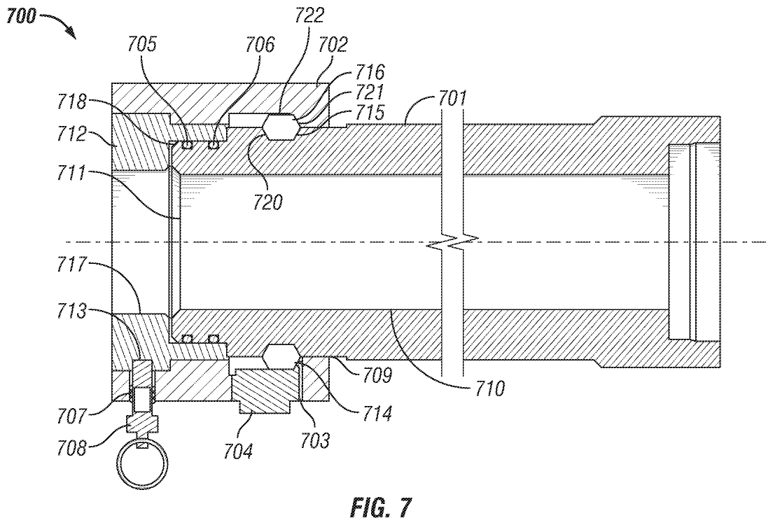

FIG. 7 is a cross-section view of an adjustable expansion spool utilizing an embodiment of the segmented ring. The main body 701 is inserted into a collar 702 through a collar aperture 709. Once inserted, the end 711 of the main body 701 is adjacent to a pipe connection 712 such that a connection fluid channel 717 is in line with a main fluid channel 710 and fluid can travel between the two pipes. After the main body 701 has been inserted into the collar 702, a retainer plug 704 that is housed in a retainer hole 703 is removed. When the retainer plug 704 is removed, a main groove 715 and a collar groove 722 are exposed. The main groove 715 traverses the outer circumference of the main body 701 and the collar groove 722 traverses the inner circumference of the collar 702.

With the two grooves exposed, similar to other applications discussed above, a segmented ring 716 can be inserted through the retainer hole 703 until the segmented ring 716 encircles the collar groove 722 and the main groove 715. After the segmented ring 716 has been installed, the retainer plug 704 is reinserted into the retaining hole 703. When fluid pressure is applied to the expansion spool system 700, the main groove 715 engages the segmented ring 716 along a main bearing surface 720 pressing the segmented ring 716 against collar groove 722 along a collar bearing surface 721. As a result, the segmented ring 716 is put under compression instead shear.

A first o-ring 705 and a second o-ring 706 can be also housed in o-ring grooves that traverse the outer surface of the main body 701 near the body/connection interface 718 to create a seal. The collar 702 is secured to the connection pipe 712 by the insertion of a locking pin 708 through a locking pin hole 707 in the collar 702. The locking pin 707 traverses the entire depth of the collar 702 and engages a pocket 713 on the outer surface of the connection pipe 712.

Note that the angled groove surface that is opposite the main bearing surface 720 in main groove 715 does not have significant pressure applied to it by the ring 716 during operation of a pressurized fluid system. Likewise, the groove surface that is opposite the collar bearing surface 721 in the second component groove 722 also does not have significant pressure applied to it by the ring 716 during operation of a pressurized fluid system. As such, the shape or design of the grooves in these areas do not generally affect the type of load or forces that are applied to the ring 716 during normal operation. As a result, the angle or shape at these locations of both the groove and the ring is not critical from a design perspective.

As shown in FIG. 7, with the expansion spool fully assembled, the collar groove 722 only contacts one bearing surface of the segmented ring 716. The opposite bearing surface of the segmented ring 716 in the collar groove 722 is open such that the collar 702 could slide to the right when the locking pin 708 is not engaged. Thus, the shape of the ring and/or groove is not a consideration for the non-load bearing portions and in fact could be removed completely as illustrated by FIG. 7.

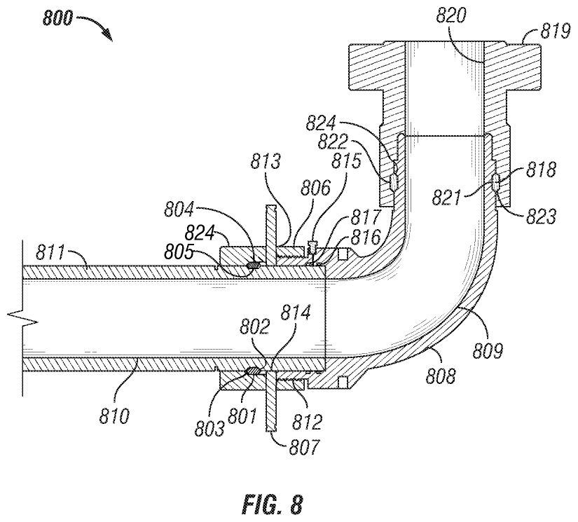

FIG. 8 is a cross-section view of a curved joint utilizing an embodiment of a segmented ring in a threaded union configuration on the bottom and a segmented swivel ring configuration on the top. A joint conduit 808 or elbow has a first end inserted into a flange swivel connector 819 and a second end inserted into a threaded union collar 806. The first end and the second end have a joint fluid channel 809. At the first end, the flange connector 819 has been configured to receive the insertion of the joint conduit 808 such that a flange fluid channel 820 is in-line with the joint fluid channel 809. A first segmented ring 818 has been positioned between the flange connector 819 and the joint conduit 808 so that it is housed in a first joint groove 821 of the joint conduit 808 and the flange groove 822 of the flange connector 819. The segmented ring operates similarly to other embodiments discussed above and allows rotation of the flange for alignment.

The second end of the joint conduit 808 has been inserted into a collar which has male pipe 811 inserted into it from the other side. The outer diameter 829 of the male pipe 811 is slightly smaller than the inner diameter 828 of the collar 806 which allows for the male pipe 811 to fit inside the collar 806. While the inner diameter of the joint conduit 809 is larger than the outer diameter of the male pipe 811, the outer diameter of the joint conduit 808 is smaller than the inner diameter of the collar along a joint/collar interface 812. Both the joint conduit 808 and the collar 806 have a matching pair of threads that allow for the joint conduit 808 and 811 to be coupled by way of the collar 806 as the joint conduit 808 is being inserted into the collar along the joint/collar interface 812. When the joint conduit has been coupled to the collar and the male pipe has been inserted into the collar, the joint fluid channel 809 is now in-line with the male pipe fluid channel 810 so that fluid may travel between them.

The collar 806 has a collar groove 804 and the male pipe 811 has a male pipe groove 805 that allows for a second segmented ring 801 to be housed between them. Again, the segmented ring operates to retain the connection between the mail pipe 811 and the collar 806 similar to the other applications discussed above. Near the interface between the joint conduit and the male pipe 810, there are two seal grooves 816, 817 that traverse the inner circumference of the joint conduit 808 and house seals to create a seal. A test port 815 is also present to allow for pressure testing of the seals.

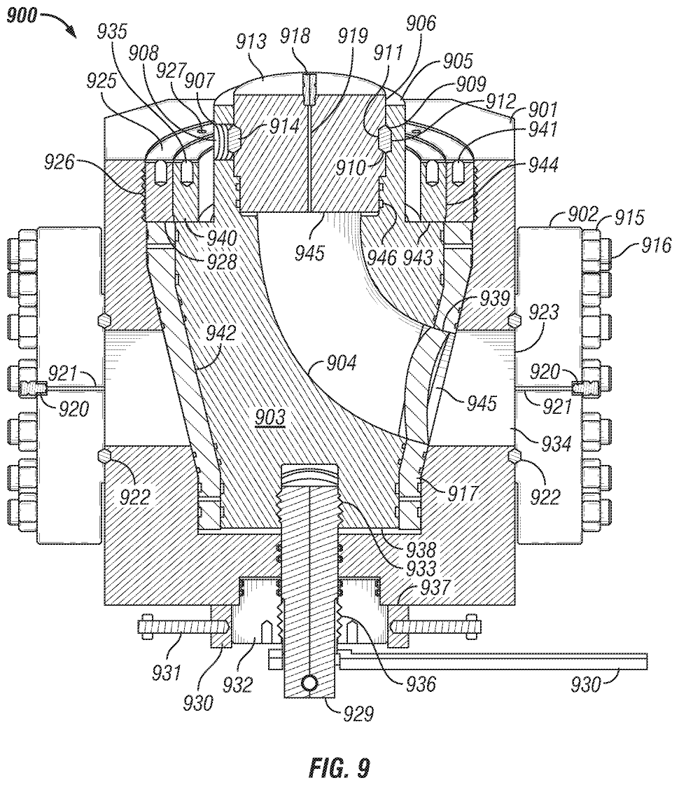

FIG. 9 is an assembly cross-section view of an isolation diverter assembly utilizing an embodiment of a segmented ring in a swivel configuration with a cross-sectional hexagon shape. The diverter assembly 900 has a plug 903 in a sleeve 919 that is housed in a diverter body 901. An inlet joint 913 can be inserted through an inlet aperture 906 into the first end 905 of the plug 903 so that an outlet end 945 is in-line with the fluid chamber 904 in the plug 903. The inlet joint 913 is inserted past the o-rings 946 that traverse the outer circumference of the inlet joint.

Housed between the first end 905 of the plug 903 in a plug groove 912 and an inlet groove 911 of the inlet joint 913 is the segmented ring 914. The segmented ring 914 can consist of eighteen (18) stainless steel metal segments that are configured to form a ring when placed adjacent to each other. The cross-section of the segmented ring 914 is in a hexagon shape. Accordingly, the plug groove 912 and the inlet groove 911 have an isosceles trapezoidal shape that matches the hexagon shape of the segmented ring 914. The purpose of the segmented ring 914 is to keep the inlet joint 913 connected to the plug 903 and operates in a similar fashion to the applications discussed above.

After the inlet joint has been inserted into the plug 903, individual segments of the segmented ring 914 can be inserted through a retainer hole 907 into the space between the inlet joint 913 and the plug 903. Once all the segments of the segmented ring 914 have been inserted, a retainer plug (not shown) can be inserted into the retainer hole 907 and secured by engaging a retainer threaded surface 908 that lines the retainer hole 907.

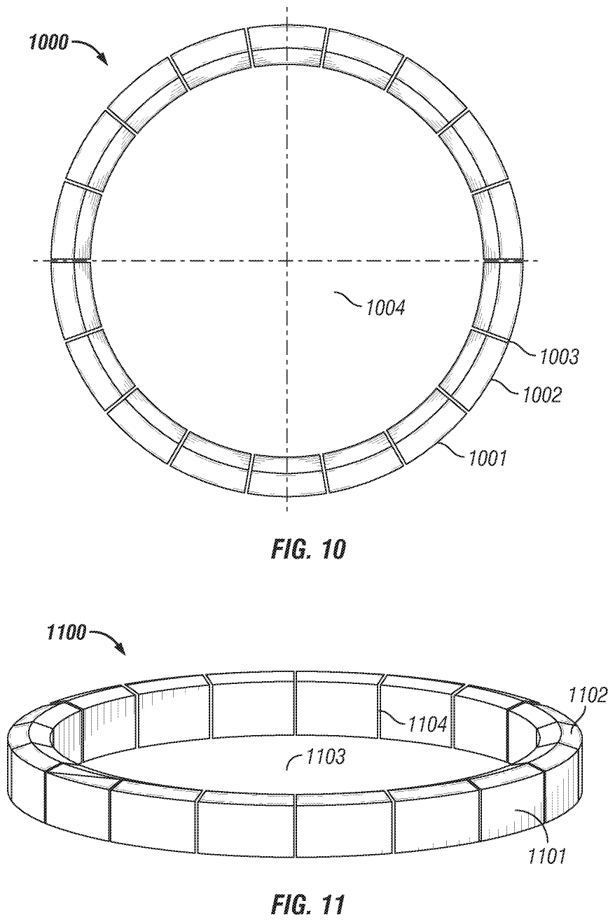

FIG. 10 is a top view of an embodiment of an assembled segmented ring. This is an example of an embodiment of a segmented ring that can be used in the various applications discussed herein. The individual segments of the segmented ring 1001 are placed end-to-end to each other along an interface 1003 to form a ring around a center aperture 1004. Each one of the segments of the segmented ring has a hexagon cross-sectional shape. This shape allows for a bearing surface 1002 on the segmented ring 1001 to experience compression and increase the amount of pressure the segmented ring 1001 can withstand compared to the pressure a ring of similar size could handle under a shear force.

FIG. 11 is a perspective view of an embodiment of the assembled segmented ring of FIG. 10. The segmented ring 1101 has multiple individual segments placed end-to-end to form a ring around a center aperture 1103. Each individual segment has a cross-sectional shape of a hexagon. The segments are placed adjacent to each other along an interface 1104. The segmented ring can have a variety of different dimensions. One embodiment of the segmented ring can have 18 individual segments that are used to assemble the segmented ring. These segments can be approximately 0.8223 inches tall by 1.93 inches wide and 1.467 inches thick. However, one with skill will understand that the segment rings can be sized or shaped differently as needed for a particular application and pressure requirement.

While this disclosure has been particularly shown and described with reference to preferred embodiments, it will be understood by those skilled in the art that various changes in form and detail may be made therein without departing from the spirit and scope of the invention. The investors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments but should be defined only in accordance with any claims and their equivalents issuing from this disclosure. Furthermore, the above advantages and features are provided in described embodiments but shall not limit the application of such issued claims to processes and structures accomplishing any or all the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called filed. Further, a description of a technology as background information is not to be construed as an admission that certain technology is prior art to any embodiments) in this disclosure. Neither is the “Brief Summary” to be considered as a characterization of the embodiments(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of the such claims shall be considered on their own merits in light of this disclosure but should not be constrained by the headings set forth herein.

We claim:

1. A retaining ring retention system comprising:
a first component coupled to a second component, the first component having a first groove, the second component having a second groove, wherein the first groove is located on a first interface surface on the first component and is adjacent to the second groove located on a second interface surface on the second component; and
a retaining ring housed between the first groove and the second groove, wherein the retaining ring comprises a first ring bearing surface and a second ring bearing surface, wherein the first ring bearing surface and the second ring bearing surface are configured such that a perpendicular line drawn from the center of the first ring bearing surface intersects the second ring bearing surface.

2. The retaining ring retention system of claim 1 wherein the first groove comprises a first groove bearing surface for mating with the first ring bearing surface and the second groove comprises a second groove bearing surface for mating with the second ring bearing surface such that when the first component and the second component are pulled in opposite directions after assembly, the retaining ring is placed under compression.

3. The retaining ring retention system of claim 1, wherein the retaining ring comprises a plurality of segments.

4. The retaining ring retention system of claim 3 wherein the first component comprises a retainer hole for allowing the plurality of segments to be inserted and a first cover for sealing the retainer hole.

5. The retaining ring system of claim 1, wherein the retaining ring has a hexagonal cross-section.

6. A retaining ring retention system comprising:
a first conduit comprising a first groove traversing the circumference of an outer surface of the first conduit near a proximal end of the first conduit;
a second conduit comprising a threaded conduit interface on an outer surface of the second conduit;
a collar for joining the first conduit to the second conduit, the collar comprising a threaded collar interface on an inner diameter for engaging the threaded conduit interface and a collar groove traversing the inner diameter;
a retaining ring housed between the first groove and the collar groove, wherein the retaining ring comprises a first ring bearing surface and a second ring bearing surface, wherein the first ring bearing surface and the second ring bearing surface are configured such that a perpendicular line drawn from the center of the first ring bearing surface intersects the second ring bearing surface.

7. The retaining ring retention system of claim 6 wherein the first groove comprises a first groove bearing surface for mating with the first ring bearing surface and the collar groove comprises a second groove bearing surface for mating with the second ring bearing surface such that when the first conduit and the second conduit are pulled in opposite directions after assembly, the retaining ring is placed under compression.

8. The retaining ring retention system of claim 6, wherein the retaining ring comprises a plurality of segments.

9. The retaining ring retention system of claim 8 wherein the collar comprises a retainer hole for allowing the plurality of segments to be inserted and a first cover for sealing the retainer hole.

10. The retaining ring system of claim 9 wherein the collar further comprises a locking mechanism for securing the collar to the second conduit.

11. The retaining ring system of claim 10 wherein the locking mechanism comprises a locking pin inserted through a locking hole and into a pocket in the second conduit.

12. The retaining ring system of claim 11 wherein the pocket is aligned with the locking hole when the threaded conduit interface is fully engaged with the threaded collar interface.

13. The retaining ring system of claim 10, wherein the locking pin comprises a pull pin.

14. The retaining ring system of claim 6, wherein the retaining ring has a hexagonal cross-section.

15. A method for utilizing a retaining ring comprising:
coupling a first component with a second component; and
housing a retaining ring in a first groove in the first component and a second groove in the second component, wherein the retaining ring comprises a first ring bearing surface adjacent to a first groove bearing surface and a second ring bearing surface adjacent to a second groove bearing surface, and wherein the orientation of the first ring bearing surface and the second ring bearing surface is configured such that a perpendicular line drawn from a center of the first ring bearing surface intersects the second ring bearing surface.

16. The method of claim 15, wherein the retaining ring comprises a plurality of segments.

17. The method of claim 16 wherein the step housing the retaining ring comprises inserting a each of the plurality of segments through a retainer hole in the first component and closing the retainer hole with a first cover.

18. The method of claim 17, wherein the first cover is a retainer plug.

19. The method of claim 15, wherein the retaining ring comprises a hexagonal cross-section.

20. A retaining ring retention system comprising:
a first conduit comprising a threaded exterior portion;
a second conduit comprising a conduit load shoulder in a conduit groove, the conduit groove traversing a circumference of the second conduit;
a collar comprising a threaded interior portion and a collar load shoulder in a collar groove, wherein the collar groove traverses an inner circumference of a collar such that the conduit groove is adjacent the collar groove; and
a retaining ring comprised of one or more pieces housed between the conduit load shoulder and the collar groove, for securing the collar to the second conduit, wherein the conduit load shoulder and the collar load shoulder are configured to put a first bearing surface and a second bearing surface of the retaining ring under compression, wherein the first conduit can be coupled to the collar by engaging the threaded exterior portion on the first conduit with the threaded interior portion of the collar.

21. The retaining ring retention system of claim 20 wherein the retaining ring has a hexagonal cross-section.
